(19) United States
(12) Patent Application Publication
(10) Pub. No.: US 2019/0294776 A1
(43) Pub. Date: Sep. 26, 2019

(54) PORTABLE ELECTRONIC DEVICE AND UNLOCKING METHOD THEREOF

(71) Applicant: Chiun Mai Communication Systems, Inc., New Taipei (TW)

(72) Inventors: YEN-HUI LIN, New Taipei (TW); SUNG-CHIEH CHANG, New Taipei (TW)

(21) Appl. No.: 16/361,487

(22) Filed: Mar. 22, 2019

(30) Foreign Application Priority Data
Mar. 23, 2018 (CN) 201810255341.1

(51) Int. Cl. G06F 21/36; G06F 3/0481; G06F 3/0488; G06K 9/00; G06F 3/01; G06F 3/0482; G06F 21/32

(52) U.S. Cl. CPC G06F 21/36; G06F 3/04817; G06F 3/04883; G06K 9/00087; G06F 21/32; G06K 9/00288; G06K 9/00617; G06F 3/013; G06F 3/0482; G06K 9/00013

(57) ABSTRACT

A portable electronic device able to transition directly from a locked state to activation of an application includes a display displaying an unlocking interface. The portable electronic device receives and validates first and second touch inputs from a user, the first input being matchable to an unlocking condition, and the application being selectable by the second input. The first and second inputs may be found together in one sliding touch. Upon validation of the first input, redirecting from the unlocking interface to a home screen if no application is selected, or to an interface of the application if one is selected. Without validation, the display continues to display the unlocking interface and no application is activated. An unlocking method of the portable electronic device is also provided.

### FIELD

The subject matter herein generally relates to security of portable electronic devices and an unlocking method of the portable electronic devices.

### BACKGROUND

An unlocking pattern may need to be drawn on a portable electronic device to unlock the system and enter a desktop from a locked status, then application icons can be touched to be activated. Furthermore, when there are too many application icons on the desktop, a page turning operation is needed to find a desired application icon. Therefore, the traditional method of unlocking and activating applications is not convenient enough for the user.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one exemplary embodiment of a portable electronic device.

FIGS. 2A-2D illustrate a first unlocking interface of the portable electronic device of one exemplary embodiment.

FIGS. 3A-3C illustrate a second unlocking interface of the portable electronic device of one exemplary embodiment.

FIG. 4 is a flow chart of a first embodiment of an unlocking method of the portable electronic device.

FIGS. 5A-5D illustrate a third unlocking interface of the portable electronic device of one exemplary embodiment.

FIGS. 6A-6C illustrate a fourth unlocking interface of the portable electronic device of one exemplary embodiment.

FIG. 7 is a flow chart of a second embodiment of an unlocking method of the portable electronic device.

FIG. 8 illustrates a fifth unlocking interface of the portable electronic device of one exemplary embodiment.

FIGS. 9A-9B illustrate a sixth unlocking interface of the portable electronic device of one exemplary embodiment.

FIG. 10 illustrates a seventh unlocking interface of the portable electronic device of one exemplary embodiment.

FIG. 11 illustrates an eighth unlocking interface of the portable electronic device of one exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

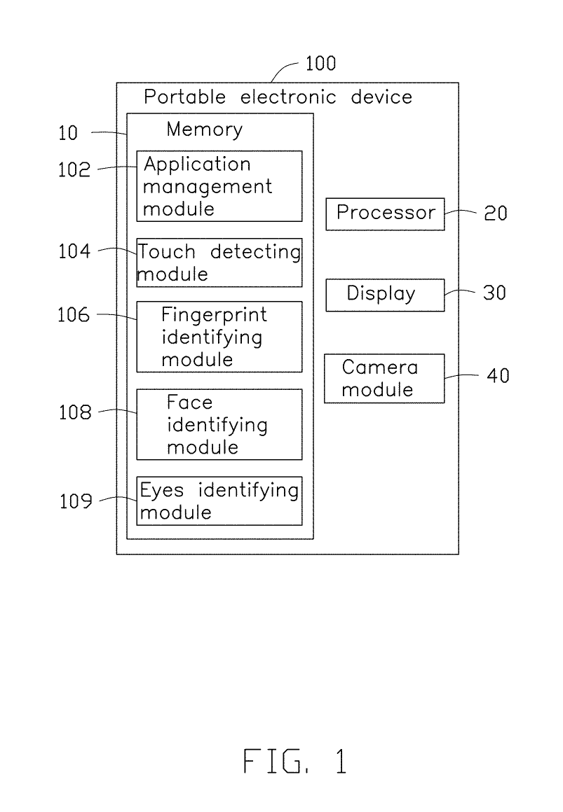

FIG. 1 illustrates an embodiment of a portable electronic device 100 including at least one unlocking interface. The unlocking interface receives unlocking operations to enter a desktop interface of an operation system of the portable electronic device 100. The desktop interface of the portable electronic device 100 includes a plurality of application icons. The portable electronic device 100 can be, but is not limited to, a mobile phone, a personal digital assistant, or a tablet computer.

The portable electronic device 100 includes a memory 10, a processor 20, a display 30, and a camera module 40. The memory 10 includes an application management module 102, a touch detecting module 104, a fingerprint identifying module 106, a face identifying module 108, and an eyes identifying module 109. The memory 10, the display 30, and the camera module 40 are electrically connected to and processed by the processor 20.

In general, the word “module,” as used herein, refers to logic embodied in hardware or firmware, or to a collection of software instructions, written in a programming language, such as, Java, C, or assembly. One or more software instructions in the modules may be embedded in firmware, such as erasable-programmable read-only memory (EPROM). The modules described herein may be implemented as either software and/or hardware modules and may be stored in any type of computer-readable medium or other storage device. Some non-limiting examples of non-transitory computer-readable medium include CDs, DVDs, BLU-RAY, flash memory, and hard disk drives. The processor 20 can be a single chip microcomputer or other micro integrated circuits. The memory 10 can be a memory of the portable electronic device 100 or an external storage device, such as a Smart Media Card, a Secure Digital Card, or a Random-Access Memory (RAM), connected to the portable electronic device 100.

The display 30 displays a user interface, the user interface at least includes an unlocking interface, the desktop interface, and an application interface. The unlocking interface, the desktop interface, and the application interface are different interfaces. The unlocking interface is for detecting unlocking operations when the operation system of the portable electronic device 100 is in a locked status. The desktop interface is for displaying selectable application icons when the operation system of the portable electronic device 100 is in a using status. The application interface displays an activated application. The unlocking interface, after receiving an unlocking operation, can be redirected to the desktop interface and the application interface. In at least one embodiment, the display 30 can be a touch display, which detects operations on the user interface through the touch detecting module 104. The display 30 may further include a fingerprint sensor (not shown) for detecting fingerprints on the display 30.

The application management module 102 is for managing the applications, including setting the applications, and providing the application interface. The touch detecting module 104 is for detecting operations on the user interface, including clicks, slides, drags, and breaking off, etc. The fingerprint detecting module 106 is for detecting fingerprints cooperatively with the fingerprint sensor. The face identifying module 108 is for identifying face of the users cooperatively with the camera module 40. The eyes identifying module 109 is for identifying irises of user and focus of user's eyes cooperatively with the camera module 40. In other embodiments, the portable electronic device 100 may only include one of the face identifying module 108 and the eyes identifying module 109.

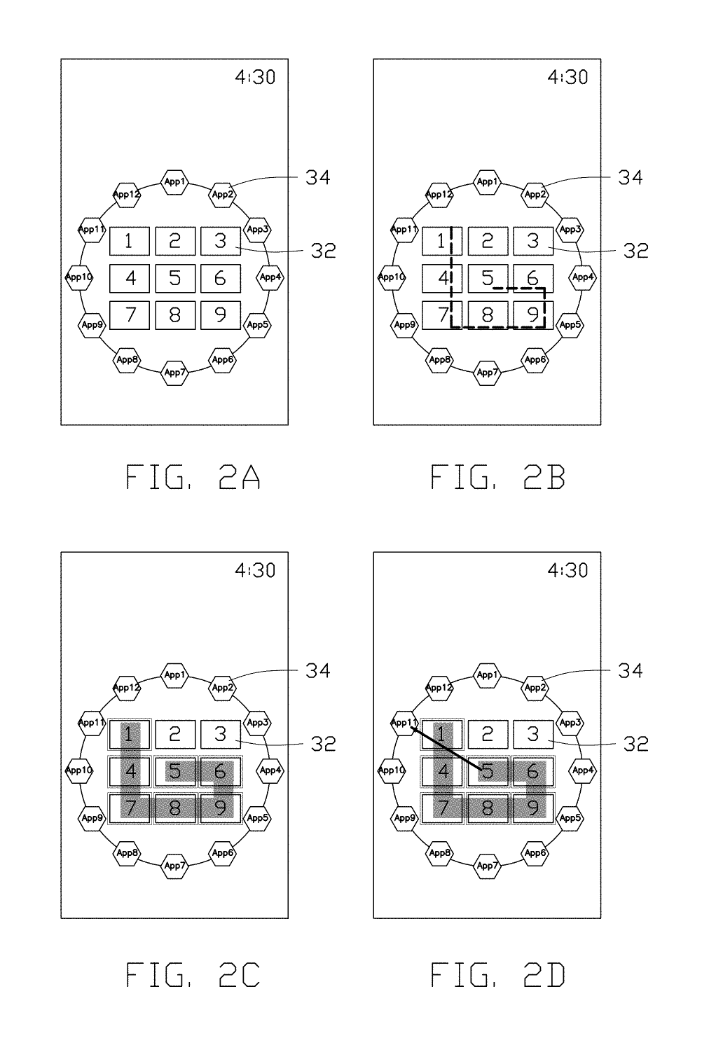

FIGS. 2A-2D illustrate a first unlocking interface displayed by the display 30. In at least one embodiment, when the display 30 is in an off status, triggered through a power button or a home bottom, the display 30 displays the first unlocking interface from the off status. The first unlocking interface includes a plurality of unlocking icons 32 and a plurality of application icons 34. The application icons 34 surround the unlocking icons 32. The arrangement of the unlocking icons 32 and the application icons 34 is not limited. In the first unlocking interface, the disposition of the unlocking icons 32 is substantially rectangular, and the disposition of the application icons 34 is substantially circular, to surround the unlocking icons 32. The touch detecting module 104 detects operations on the unlocking icons 32 from the user. In at least one embodiment, the unlocking operation is a first path of a slide on the unlocking icons 32. As shown in FIG. 2B, the first path is a slide along “1” “4” 7” “8” “9” “6” “5” of the unlocking icons 32. An end of the first path is “5”. When the touch detecting module 104 detects an end of the first path, the first path is highlighted on the unlocking icons 32, therefore the first path can be visible, as shown in FIG. 2C. The touch detecting module 104 continuously detects operations after the end of the first path. When the operation is broken off after the end of the first path, that is a touch path is discontinued at the end “5” of the first path, then unlocking is completed, redirecting from the first unlocking interface to the desktop interface. The operation being broken off means fingers of the user or a stylus leaving the display 30. When the operation continuously slides to one of the application icons 34 then breaks off, the touch detecting module 104 detects a second path and an end of the second path. Thereby an application corresponding to the application icon 34 at the end of the second path is activated, then redirecting from the first unlocking interface to the corresponding application interface. As shown in FIG. 2D, a continuous sliding from the end “5” of the first path to an application icon App 11 is then broken off. The end of the second path is the application icon App 11, causing a redirection from the first unlocking interface to the application interface corresponding to the application icon App 11.

In other embodiments, when the touch operation detected by the touch detecting module 104 does not correspond to a preset first path, then the touch detecting module 104 may not continuously detect a second path. The disposition of the unlocking icons 32 can be other icons, such as circular, or a zigzag starshape. A quantity and arrangement of the application icons 34 can be set by the application management module 102 or flexibly adjusted according to use frequency or suspending items by the application management module 102. For instance, in the first unlocking interface of FIG. 2A, applications corresponding to the application icons App 10 and App 12 have low use frequency. Herein user may remove the application icons App 10 and App 12 from the first unlocking interface through the application management module 102. When the applications have suspending items, such as e-mail application with unread e-mails, the application management module 102 may add the application icons corresponding to the applications with suspending items to the first unlocking interface.

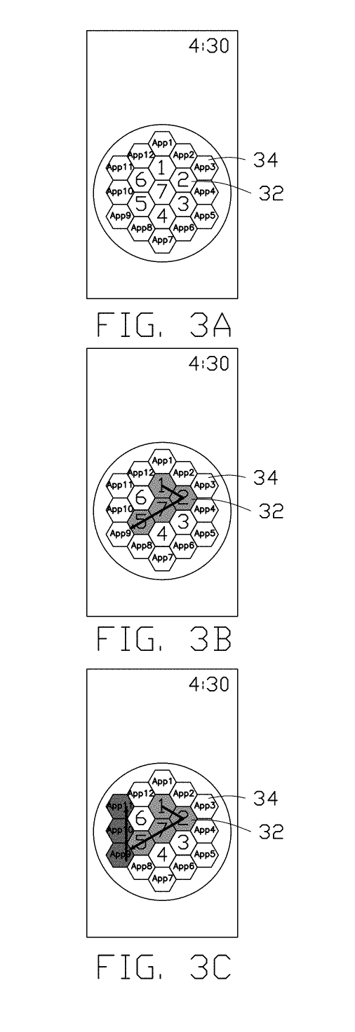

FIGS. 3A-3C illustrate a second unlocking interface displayed by the display 30. In at least one embodiment, when the display 30 is in an off status, triggered through a power button or a home bottom, the display 30 displays the second unlocking interface from the off status. The second unlocking interface includes an unlocking icons 32 and application icons 34. The unlocking icons 32 and the application icons 34 are arranged in a honeycomb shape. The application icons 34 surround the unlocking icons 32. In the second unlocking interface, the touch detecting module 104 detecting first path and second path which are substantially similar to those in the first unlocking interface. As shown in FIG. 3B, the first path is a slide along “1” “2” 7” “5” of the unlocking icons 32 with an end of “5”. The second path is a slide along “5” of the unlocking icons 32 and through “App 9” “App 10” “App 11” of the application icons 34, ending at “App 11”. Since the touch detecting module 104 detects that “App 11” is the end of the second path, then activating application App 11, and redirecting from the second unlocking interface to the application interface of App 11 (not shown).

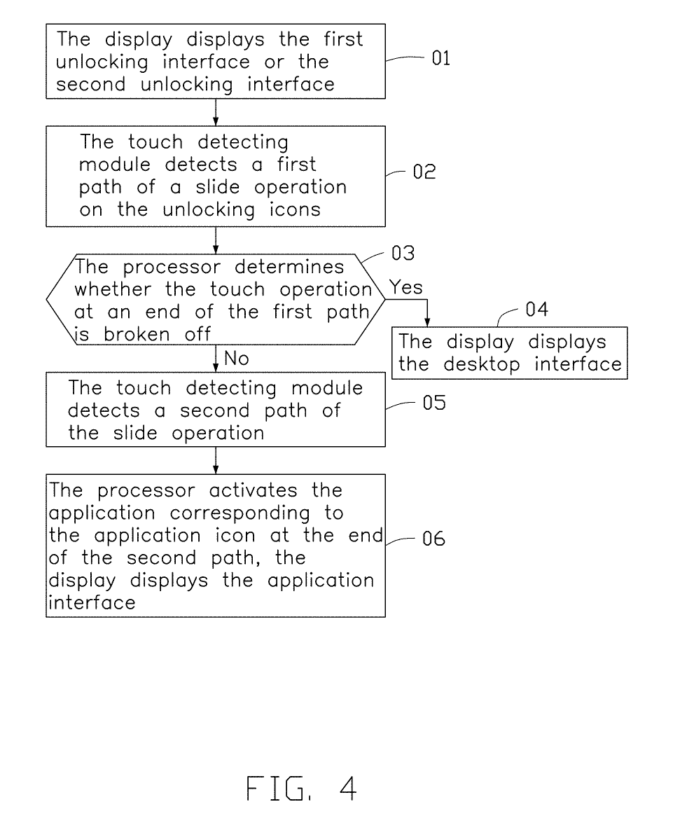

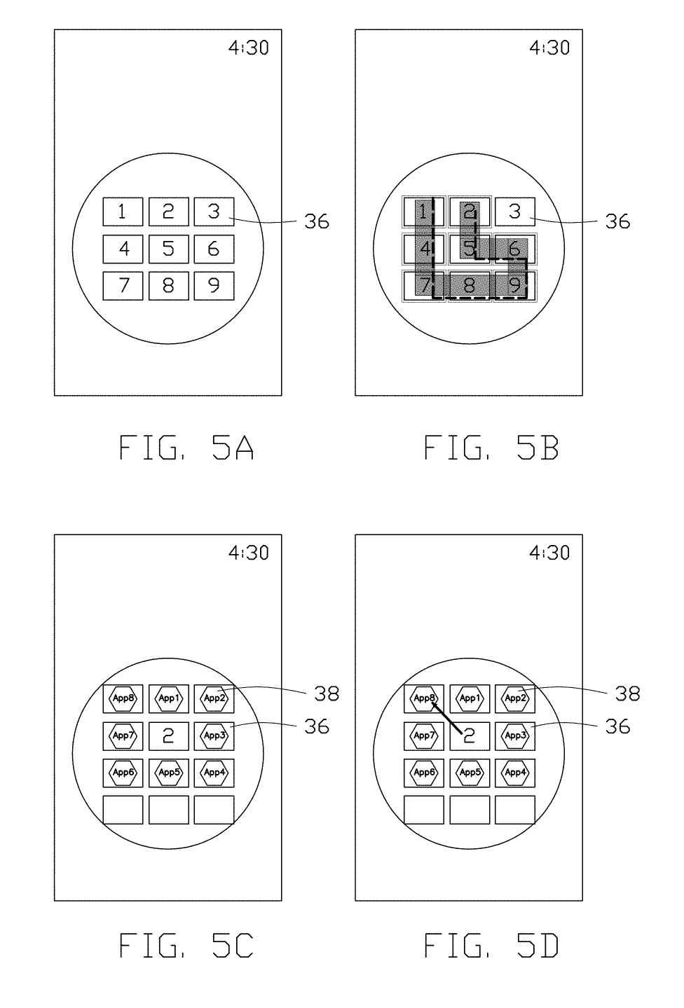

Referring to FIG. 4, a flowchart of a method is presented in accordance with a first embodiment. The example unlocking method of the portable electronic device 100 can be carried out using the configurations illustrated in FIG. 1, for example, and various elements of these figures are referenced in example method. Each block shown in FIG. 4 represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 01.

At block 01, the display 30 displays the first unlocking interface or the second unlocking interface. The first unlocking interface or the second unlocking interface includes a plurality of unlocking icons 32 and a plurality of application icons 34. The application icons 34 are disposed to surround the unlocking icons 32. In at least one embodiment, when the display 30 triggered through a power button or a home bottom from an off status, the display 30 displays the first unlocking interface or the second unlocking interface from the off status.

At block 02, the touch detecting module 104 detects a first path of a slide operation on the unlocking icons 32. In at least one embodiment, the first path is a preset unlocking path, which is stored in the memory 10. The touch detecting module 104 detects a slide operation on the unlocking icons 32 and determines whether this corresponds to the first path. When the detected slide operation is found to correspond to the first path, a next block is processed. When the detected slide operation is found to not correspond to the first path, an error is displayed on the first unlocking interface or the second unlocking interface, and the current block is repeatedly processed, the display 30 continues to display the first unlocking interface or the second unlocking interface.

At block 03, the processor 20 determines whether the touch operation at an end of the first path is broken off. When the processor 20 determines touch operation at the end of the first path is broken off, then block 04 is processed. When processor 20 determines touch operation at the end of the first path is not broken off, then block 05 is processed. In at least one embodiment, after the touch detecting module 104 detects the first path, the first path is highlighted on the unlocking icons 32, therefore the first path can be visible.

At block 04, the display 30 displays the desktop interface. After unlocking the system, the display 30 displays the desktop interface redirected from the first unlocking interface or the second unlocking interface.

At block 05, the touch detecting module 104 detects a second path of the slide operation. The second path is a slide operation from the end of the first path to one of the application icons 34 and then being broken off. The touch detecting module 104 detects an end of the second path and a certain application icon 34 at the end of the second path. In at least one embodiment, no matter which unlocking icons 32 and application icon 34 the second path passes through, only the application icon 34 at the end of the second path, as detected by the touch detecting module 104, is activated.

At block 06, the processor 20 activates the application corresponding to the application icon 34 at the end of the second path, and the display 30 displays the application interface. In at least one embodiment, after an application is activated, the display 30 displays the application interface redirected from the first unlocking interface or the second unlocking interface. After entering the application interface, the touch detecting module 104 detects normal touch operations on the application interface.

FIGS. 5A-5D illustrate a third unlocking interface displayed by the display 30. In at least one embodiment, when the display 30 is in an off status, triggered through a power button or a home bottom, the display 30 displays the third unlocking interface from the off status. The third unlocking interface includes a plurality of unlocking icons 36. A quantity and an arrangement of the unlocking icons 36 are not limited. In the third unlocking interface, the disposition of the unlocking icons 36 is substantially rectangular, as shown in FIG. 5A. The touch detecting module 104 detects unlocking operations on the unlocking icons 36 from the user. In at least one embodiment, the unlocking operation is a first path of a sliding touch on the unlocking icons 36. As shown in FIG. 5B, the first path is a slide along “1” “4” 7” “8” “9” “6” “5” “2” of the unlocking icons 36. An end of the first path is “2”. When the touch detecting module 104 detects an end of the first path, the first path is highlighted to reveal the unlocking icons 36. Then the display 30 removes the highlighting of the first path and displays application icons 38, as shown in FIG. 5C. In detail, the display 30 displays the application icons 38 surrounding the end of the “2” of the first path. A quantity and an arrangement of the application icons 38 are not limited. In the third unlocking interface, the application icons 38 are arranged in a rectangular array. The touch detecting module 104 continues to detect operations after the end of the first path. When the operation is broken off at the end of the first path, that is after the “2” of the first path, then unlocking is completed, and redirection from the third unlocking interface to the desktop interface occurs. The break off operation means fingers of the user or a stylus leave the display 30. When the operation continuously slides to one of the application icons 34 and then breaks off, the touch detecting module 104 detects a second path and an end of the second path, thus activating an application corresponding to the application icon 38 that is at the end of the second path. The redirection from the third unlocking interface to the corresponding application interface then occurs. As shown in FIG. 5D, there is continuous sliding from the end “2” of the first path to an application icon App 8 and then a break-off, thus, the end of the second path is the application icon App 8, and then redirection from the third unlocking interface to the application interface corresponding to the application icon App 8.

In other embodiments, when the touch operation detected by the touch detecting module 104 does not correspond to a preset first path, then the touch detecting module 104 cannot detect a second path. The disposition of the unlocking icons 36 can be other icons, such as circular, or in a starshape. A quantity and arrangement of the application icons 38 can be set by the application management module 102 or flexibly adjusted according to use frequency or suspending items by the application management module 102.

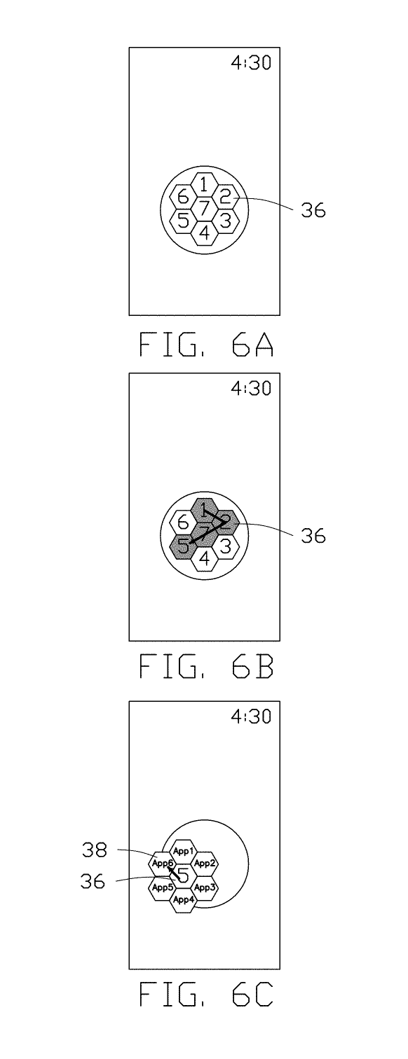

FIGS. 6A-6C illustrate a fourth unlocking interface displayed by the display 30. In at least one embodiment, when the display 30 is in an off status, triggered from an off status through a power button or a home bottom, the display 30 displays the fourth unlocking interface from the off status. The fourth unlocking interface includes a plurality of unlocking icons 36 arranged in a honeycomb shape, as shown in FIG. 6A. In the fourth unlocking interface, the touch detecting module 104 being able to detect the first path and the second path is substantially similar to that process in the third unlocking interface. As shown in FIG. 6B, the first path is a slide along “1” “2” 7” “5” of the unlocking icons 36 with an end of “5”. The second path is a slide along “5” of the unlocking icons 36 and along to “App 6” of the application icons 38, ending at “App 6”, as shown in FIG. 6C. Since the touch detecting module 104 detects that the end of the second path is “App 6”, App 6 is activated, redirecting from the third unlocking interface to the application interface of App 6 (not shown).

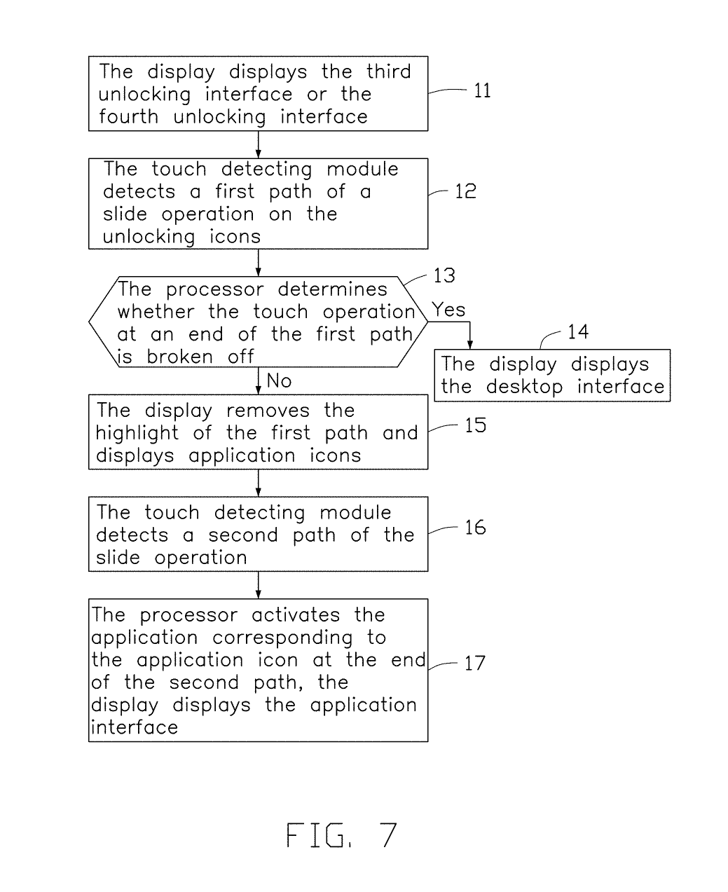

Referring to FIG. 7, a flowchart of a method is presented in accordance with a second embodiment. The example unlocking method of the portable electronic device 100 can be carried out using the configurations illustrated in FIG. 1, for example, and various elements of these figures are referenced in example method. Each block shown in FIG. 7 represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 11.

At block 11, the display 30 displays the third unlocking interface or the fourth unlocking interface. The first unlocking interface or the second unlocking interface includes a plurality of unlocking icons 36. In at least one embodiment, when the display 30 is in an off status, triggered from the off status through a power button or a home bottom, the display 30 displays the third unlocking interface or the fourth unlocking interface.

At block 12, the touch detecting module 104 detects a first path of a slide operation on the unlocking icons 36. In at least one embodiment, the first path is a preset unlocking path, the preset path being stored in the memory 10. The touch detecting module 104 detects slides operation on the unlocking icons 36 and determines a correspondence to the first path or otherwise. When the detected slide operation is corresponding to the first path, a next block is processed. When the detected slide operation is not corresponding to the first path, an error is displayed on the first unlocking interface or the second unlocking interface, and the current block is repeated. The display 30 continues to display the third unlocking interface or the fourth unlocking interface.

At block 13, the processor 20 determines whether the touch operation at an end of the first path is broken off. When the processor 20 determines that touch operation at the end of the first path is broken off, block 14 is processed. When the processor 20 determines that touch operation at the end of the first path is not broken off, then block 15 is processed. In at least one embodiment, after the touch detecting module 104 detects the first path, the first path is highlighted on the unlocking icons 36, therefore the first path is visible.

At block 14, the display 30 displays the desktop interface. After unlocking the system, the display 30 displays the desktop interface, redirected from the third unlocking interface or the fourth unlocking interface.

At block 15, the display 30 removes the highlighting of the first path and displays application icons 38. In detail, the display 30 displays the application icons 38 surrounding the end of the first path. A quantity and an arrangement of the application icons 38 are not limited. The application icons 38 may be arranged in a rectangular or honeycomb shape.

At block 16, the touch detecting module 104 detects a second path of the slide operation. The second path is a slide operation from the end of the first path to one of the application icons 38 and then broken off. The touch detecting module 104 detects an end of the second path and an application icon 38 at such end. In at least one embodiment, no matter which unlocking icons 36 and application icon 38 the second path passes through, only the application icon 38 at the end of the second path, as detected by the touch detecting module 104, is activated.

At block 17, the processor 20 activates the application corresponding to the application icon 38 at the end of the second path, and the display 30 displays the application interface. In at least one embodiment, after the application is activated, the display 30 displays the application interface redirected from the third unlocking interface or the fourth unlocking interface. After entering the application interface, the touch detecting module 104 detects normal touch operations on the application interface.

In at least one embodiment, in the first unlocking interface and the second unlocking interface, the unlocking icons 32 and the application icons 34 are simultaneously displayed in a partitioned single interface. In the third unlocking interface and the fourth unlocking interface, the unlocking icons 36 and the application icons 38 are displayed in time division and without a partition in a single interface. The first path and the second path of the slide operation is a continuous and uninterrupted path, the finger or the stylus does not leave the display 30 during the first path and the second path of the slide operation.

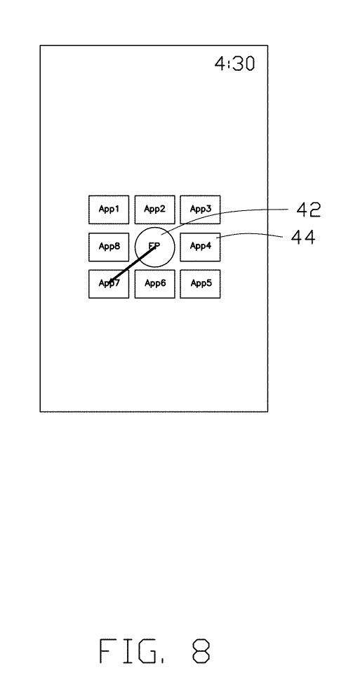

Referring to FIG. 8, the display 30 further includes a fingerprint identifying zone 42. The fingerprint sensor is arranged to correspond to the fingerprint identifying zone 42 for cooperatively detecting fingerprints on the fingerprint identifying zone 42. The memory 10 stores fingerprint data. In at least one embodiment, when the display 30 is in the off status, the fingerprint identifying module 106 can detect fingerprints from touches on the fingerprint identifying zone 42. The processor 20 can determine whether a detected fingerprint is matched to the fingerprint data. When the detected fingerprint is not matched, then unlocking the system does not take place, and the display 30 remains in the off status. When the detected fingerprint is matched to the fingerprint data, then unlocking the system is permitted, and the display 30 displays a fifth unlocking interface. The fifth unlocking interface includes application icons 44. A quantity and an arrangement of the application icons 44 are not limited. In the fifth unlocking interface, the application icons 44 are arranged in a rectangular shape to surround the fingerprint identifying zone 42. The touch detecting module 104 detects touch operations on the fifth unlocking interface. When the touch operation detected by the touch detecting module 104 is broken off, then a redirection from the fifth unlocking interface to the desktop interface takes place. When the touch operation detected by the touch detecting module 104 is a slide operation with a second path and only then broken off, the touch detecting module 104 detects the second path and an end of the second path. The application corresponding to the application icon 46 at the end of second path is then activated, together with a redirection from the fifth unlocking interface to the application interface.

In other embodiments, the fingerprint sensor can be arranged apart from the display 30.

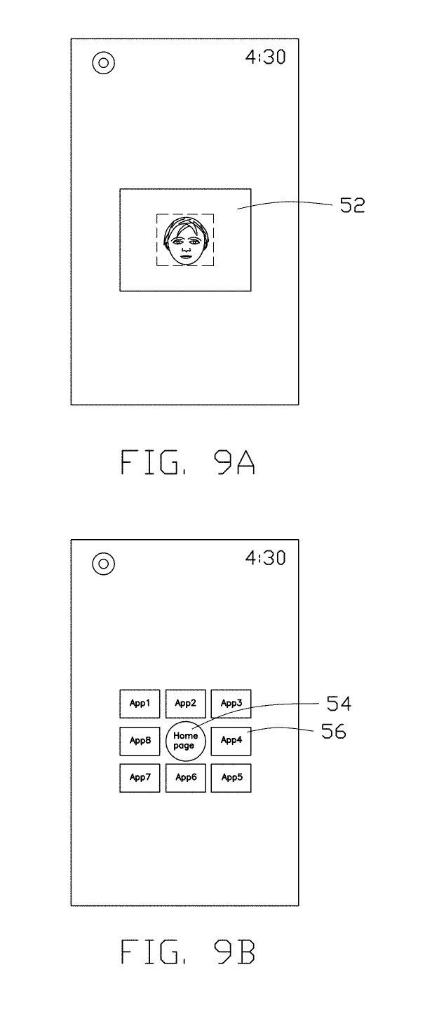

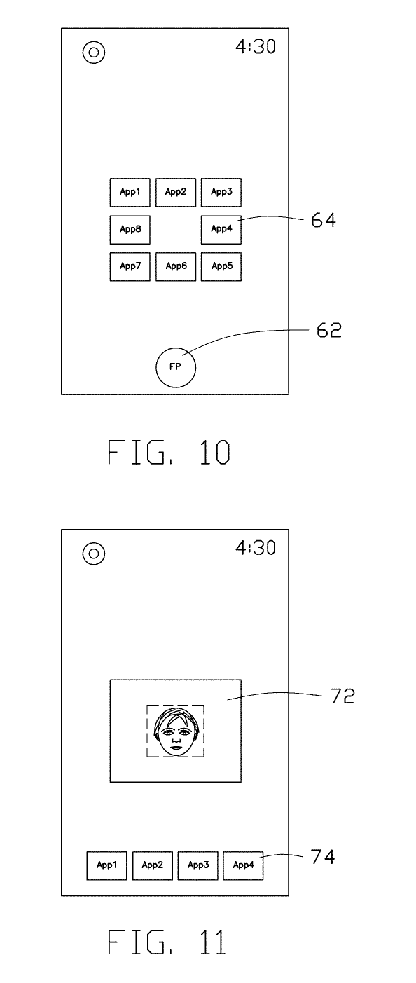

FIG. 9A illustrates a sixth unlocking interface displayed by the display 30. In at least one embodiment, when the display 30 is in an off status, triggered from an off status through a power button or a home bottom, the display 30 displays the sixth unlocking interface. The sixth unlocking interface includes an image identifying zone 52 for displaying facial image of the user. The memory 10 stores facial characteristics data. The camera module 40 is aligned to the face of the user for capturing a facial image of the user, and the image identifying zone 52 displays the facial image. The face identifying module 108 identifies the facial image, and the processor 20 determines whether the identified facial image is matched to the facial characteristics data. When the identified facial image is not matched, then the system remains locked, the sixth unlocking interface continues to be displayed. When the identified facial image is matched to the facial characteristics data, then unlocking the system is permitted, and the display 30 displays a home screen icon 54 and application icons 56 in the sixth unlocking interface, as shown in FIG. 9B. A quantity and an arrangement of the application icons 56 are not limited. In the sixth unlocking interface, the application icons 56 are arranged in a rectangular shape to surround the home screen icon 54. The touch detecting module 104 detects touch operations on the sixth unlocking interface. When the touch operation detected by the touch detecting module 104 is a touch on the home screen icon 54, then redirection from the sixth unlocking interface to the desktop interface occurs. When the touch operation detected by the touch detecting module 104 is on one of the application icons 56, then the application corresponding to the application icon 56 is activated, and there is redirection from the sixth unlocking interface to the application interface.

In at least one embodiment, before displaying the sixth unlocking interface, the face of the user must be identified. In other embodiments, the unlocking can be identifying the irises of the user. The memory 10 stores irises data. The eyes identifying module 109 detects eyes and irises from the facial image of the user. If the processor 20 determines that the detected irises are matched to the irises data, then unlocking the system is permitted. Further unlocking processes are substantially similar to those described in the previous paragraph.

In other embodiments, the face identifying and iris identifying can be individually processed. When one or other of the face identifying and iris identifying succeeds, then unlocking the system is permitted. Otherwise, face identifying and iris identifying can be concurrently processed, and only when both of the face identifying and iris identifying succeed is the system unlocked.

FIG. 10 illustrates a seventh unlocking interface displayed by the display 30. In at least one embodiment, when the display 30 is triggered from an off status through a power button or a home bottom, the display 30 displays the seventh unlocking interface. The seventh unlocking interface includes a fingerprint identifying zone 62 and application icons 64. The fingerprint identifying zone 62 is arranged on one end of the display 30. A quantity and an arrangement of the application icons 64 are not limited. In the seventh unlocking interface, the application icons 64 are arranged in a rectangular shape and separated from the fingerprint identifying zone 62. The fingerprint identifying module 106 detects fingerprints from touches on the fingerprint identifying zone 62, the processor 20 then determines whether the detected fingerprint is matched to the fingerprint data. When the detected fingerprint is not matched, unlocking the system is not permitted, and the display 30 continuously displays the seventh unlocking interface. When the detected fingerprint is matched to the fingerprint data, then the system is unlocked. Then the camera module 40 is aligned to the eyes of the user for capturing an eyes image of the user. The eyes identifying module 109 identifies the eyes image, the processor 20 determines whether the eyes are focusing on one particular application icon 64. When the eyes are so focused, then there is redirection from the seventh unlocking interface to the desktop interface. When the eyes are focused on one particular application icon 64, then the corresponding application is activated, and there is redirection from the seventh unlocking interface to the application interface.

FIG. 11 illustrates an eighth unlocking interface displayed by the display 30. In at least one embodiment, when the display 30 is triggered, the display 30 displays the eighth unlocking interface. The eighth unlocking interface includes an image identifying zone 72 and application icons 74. A quantity and an arrangement of the application icons 74 are not limited. In the eighth unlocking interface, the application icons 74 are arranged in a line and are separate from the image identifying zone 72. The camera module 40 is aligned to the face of the user for capturing a facial image of the user, and the image identifying zone 72 displays the facial image. The face identifying module 108 identifies the facial image, and the processor 20 determines whether the identified facial image is matched to the facial characteristics data. When the identified facial image is not matched, unlocking the system is not permitted, and the display 30 continuously displays the eighth unlocking interface. When the identified facial image is matched to the facial characteristic data, then unlocking the system is allowed, then the touch detecting module 104 detects normal touch operations on the eighth unlocking interface. When the touch operation detected by the touch detecting module 104 is not on any of the application icons 74, then redirection from the eighth unlocking interface to the desktop interface takes place. When the touch operation detected by the touch detecting module 104 includes a touch on one of the application icons 74, then the application corresponding to the application icon 74 is activated, and redirection from the sixth unlocking interface to the application interface occurs.

In another embodiment, in the eighth unlocking interface, the camera module 40 is aligned to the face of the user for capturing a facial image of the user, the image identifying zone 72 displaying the facial image. The eyes identifying module 109 detects irises from the facial image of the user. When the processor 20 determines that the detected irises are matched to the irises data, then the system is unlocked. When the processor 20 determines that the detected irises are not matched to the irises data, then the system is not unlocked, the display 30 continuously displays the eighth unlocking interface. After unlocking the system, the touch detecting module 104 detects normal touch operations of the user. When the touch detecting module 104 detects no touch operation or no touch operations on one of the application icons 74, then the display 30 redirects from the eighth unlocking interface to the desktop interface. When the touch detecting module 104 detects a touch operation on one of the application icons 74, then the application corresponding to the application icon 74 is activated, and a redirecting from the eighth unlocking interface to the application interface takes place.

In another embodiment, in the eighth unlocking interface, the camera module 40 is aligned to the face of the user for capturing a facial image of the user, the image identifying zone 72 displaying the facial image. The face identifying module 108 identifies the facial image, and the processor 20 determines whether the identified facial image is matched to the facial characteristics data. When the identified facial image is not matched, then the system is not unlocked, and the display 30 continuously displays the eighth unlocking interface. When the identified facial image is matched to the facial characteristics data, then the system is unlocked. Then the eyes identifying module 109 identifies the eyes image, and the processor 20 determines whether the eyes are focusing on one of the application icons 74. When the eyes are not so focusing, then redirecting from the eighth unlocking interface to the desktop interface takes place. When the eyes are focusing on one of the application icons 74, then the corresponding application is activated, and a redirecting from the eighth unlocking interface to the application interface takes place.

In another embodiment, in the eighth unlocking interface, the camera module 40 is aligned to the face of the user for capturing a facial image of the user, the image identifying zone 72 displaying the facial image. The eyes identifying module 109 detects irises from the facial image of the user. If the processor 20 determines that the detected irises match the irises data, then the system is unlocked. If the processor 20 determines that the detected irises are not matched, then the system is not unlocked, the display 30 continuously displaying the eighth unlocking interface. After the system is unlocked, the eyes identifying module 109 identifies the eyes image, and the processor 20 determines whether the eyes are focusing on one application icon 74. When the eyes are not focusing on one application icon 74, then a redirection from the eighth unlocking interface to the desktop interface takes place. When the eyes are found to be focusing on one of the application icons 74, then activation of the application corresponding to the application icon 74 takes place, and a redirection from the eighth unlocking interface to the application interface.

From the first unlocking interface to the eighth unlocking interface of the unlocking method of the portable electronic device 100, touch operations from the user in a single unlocking interface are detected, to redirect the display to the desktop interface or to one of the application interfaces. When redirecting directly to the application interface from the unlocking interface, a speed of unlocking and activating the applications is increased and a user's experience is improved.

The embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims. It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A portable electronic device, comprising:
a display displaying an unlocking interface;
wherein the portable electronic device receives and validates a first input and a second input, determines whether the first input is matched to an unlocking condition, and determines an application selected by the second input;
wherein when the portable electronic device determines the first input is matched to the unlocking condition, then activating the application selected by the second input and redirecting to an interface of the application selected by the second input from the unlocking interface;
wherein the receiving of the first input and the second input, the validating of the first input and the second input, and the activating of the application are all processed in the unlocking interface;
wherein when the portable electronic device determines the first input is not matched to the unlocking condition, the display continuously displays the unlocking interface, the portable electronic device does not activate any applications.

2. The portable electronic device as claimed in claim 1, wherein the unlocking interface comprises a plurality of unlocking icons and a plurality of application icons, the first input is a first path of a slide operation on the plurality of unlocking icons, the second input is a second path of a slide operation from an end of the first path to one of the plurality of application icons, the application selected by the second input is an application corresponding to one of the plurality of application icons at an end of the second path; when the first path is matched to a preset path, the portable electronic device determines the first input is matched to the unlocking condition, otherwise the first input is not matched to the unlocking condition.

3. The portable electronic device as claimed in claim 2, wherein the portable electronic device displays the plurality of unlocking icons on the unlocking interface, then displays the plurality of application icons surrounding the end of the first path after determining the first input is matched to the unlocking condition.

4. The portable electronic device as claimed in claim 1, further comprising a memory, wherein the memory stores a fingerprint database, the display further comprises a fingerprint sensor and a fingerprint identifying zone, the fingerprint sensor is correspondingly installed to the fingerprint identifying zone, the first input is a fingerprint detected by the fingerprint sensor; when the detected fingerprint is matched to one fingerprint data stored in the fingerprint database, the portable electronic device determines the first input is matched to the unlocking condition, otherwise determining the first input is not matched to the unlocking condition.

5. The portable electronic device as claimed in claim 4, wherein after the portable electronic device determines the detected fingerprint is matched to the one fingerprint data stored in the fingerprint database, the unlocking interface displays a plurality of application icons, the second input is a path of slide operation from the fingerprint identifying zone to one of the plurality of application icons, the application selected by the second input is an application corresponding to one of the plurality of the application icons at an end of the path of slide operation.

6. The portable electronic device as claimed in claim 1, further comprising a camera module and a memory, wherein the memory stores facial characteristic data or irises data, the first input is a facial image or an eyes image captured by the camera module, when the portable electronic device determines the facial image is matched to the facial characteristic data or the eyes image is matched to the irises data, then determines the first input is matched to the unlocking condition, otherwise the first input is not matched to the unlocking condition.

7. The portable electronic device as claimed in claim 6, wherein the unlocking interface comprises a plurality of application icons, the second input is touch operations on the unlocking interface, the application selected by the second input is an application corresponding to the application icon receives the touch operation.

8. The portable electronic device as claimed in claim 7, wherein the unlocking interface comprises a home screen icon, when the portable electronic device detects the touch operation on the home screen icon, then redirects from the unlocking interface to a home screen of the portable electronic device.

9. The portable electronic device as claimed in claim 8, wherein after the portable electronic device determines the first input is matched to the unlocking conditions, then the unlocking interface displays the home screen icon and the plurality of application icons.

10. The portable electronic device as claimed in claim 6, the portable electronic device determines an application icon that the eyes are focusing on according to the eyes image, the application selected by the second input is the one application corresponding to the application icon that the eyes are focusing on.

11. An unlocking method of a portable electronic device, the unlocking method comprising:
displaying an unlocking interface;
receiving a first input and a second input;
validating whether the first input is matched to an unlocking condition; and
determining an application selected by the second input;
wherein the when the portable electronic device determines the first input is matched to the unlocking condition, then activating the application selected by the second input and redirecting to an interface of the application selected by the second input from the unlocking interface;
wherein the receiving of the first input and the second input, the validating of the first input and the second input, and the activating of the application are all processed in the unlocking interface; and
wherein when the portable electronic device determines the first input is not matched to the unlocking condition, the display continuously displays the unlocking interface, the portable electronic device does not activate any applications.

12. The unlocking method as claimed in claim 11, further comprising:
displaying a plurality of unlocking icons and a plurality of application icons on the unlocking interface, the first input is a first path of a slide operation on the plurality of unlocking icons, the second input is a second path of a slide operation from an end of the first path to one of the plurality of application icons, the application selected by the second input is an application corresponding to one of the plurality of application icons at an end of the second path;
when the first path is matched to a preset path, the portable electronic device determines the first input is matched to the unlocking condition, otherwise the first input is not matched to the unlocking condition.

13. The unlocking method as claimed in claim 12, further comprising:
displaying the plurality of unlocking icons on the unlocking interface, then displaying the plurality of application icons surrounding the end of the first path after determining the first input is matched to the unlocking condition.

14. The unlocking method as claimed in claim 11, further comprising:
storing a fingerprint database; and
providing a fingerprint sensor and a fingerprint identifying zone, the fingerprint sensor is correspondingly installed to the fingerprint identifying zone, the first input is a fingerprint detected by the fingerprint sensor;
wherein when the detected fingerprint is matched to one fingerprint data stored in the fingerprint database, the portable electronic device determines the first input is matched to the unlocking condition, otherwise determining the first input is not matched to the unlocking condition.

15. The unlocking method as claimed in claim 14, further comprising:
after determining the detected fingerprint is matched to the one fingerprint data stored in the fingerprint database, displaying a plurality of application icons on the unlocking interface;
wherein the second input is a path of slide operation from the fingerprint identifying zone to one of the plurality of application icons, the application selected by the second input is an application corresponding to one of the plurality of the application icons at an end of the path of slide operation.

16. The unlocking method as claimed in claim 11, further comprising:
storing facial characteristic data or irises data;
wherein the first input is a facial image or an eyes image captured by a camera module; and
determining the first input is matched to the unlocking condition, otherwise the first input is not matched to the unlocking condition when the facial image is matched to the facial characteristic data or the eyes image is matched to the irises data is determined.

17. The unlocking method as claimed in claim 16, further comprising:
displaying a plurality of application icons on the unlocking interface;
wherein the second input is touch operations on the unlocking interface, the application selected by the second input is an application corresponding to the application icon receives the touch operation.

18. The unlocking method as claimed in claim 17, further comprising
displaying a home screen icon on the unlocking interface;
wherein when the portable electronic device detects the touch operation on the home screen icon, then redirects from the unlocking interface to a home screen of the portable electronic device.

19. The unlocking method as claimed in claim 18, wherein after the portable electronic device determines the first input is matched to the unlocking conditions, then the unlocking interface displays the home screen icon and the plurality of application icons.

20. The unlocking method as claimed in claim 16, wherein the portable electronic device determines an application icon that the eyes are focusing on according to the eyes image, the application selected by the second input is the one application corresponding to the application icon that the eyes are focusing on.
